(19) United States
(12) Patent Application Publication
(10) Pub. No.: US 2009/0074054 A1
(43) Pub. Date: Mar. 19, 2009

(54) RESOLUTION-CONVERTING APPARATUS, RESOLUTION-CONVERTING METHOD AND PREVIEWING APPARATUS

(76) Inventor: Hiroyuki MIYAUCHI, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/204,134

(22) Filed: Sep. 4, 2008

(30) Foreign Application Priority Data
Sep. 19, 2007 (JP) 2007-243058

(51) Int. Cl. H04N 11/02

(52) U.S. Cl. 375/240.01; 348/441; 375/E07.088

(57) ABSTRACT

A resolution-converting apparatus includes an input interface, a parameter calculator, a first converter, a decoder, and a second converter. The input interface inputs a video content compression-encoded and having first resolution, together with a second resolution which has been designated and which is lower than the first resolution. The parameter calculator calculates value n (natural number) when 1/2ⁿ times the first resolution is higher than the second resolution. The first converter converts the video content of the first resolution in a frequency domain, to a video content having 1/2ⁿ times the first resolution, by using the value n calculated by the parameter calculator. The decoder decodes the video content converted by the first converter. The second converter converts, in a space domain, the resolution of the video content decoded, to a video content of the designated second resolution.

### CROSS-REFERENCE TO RELATED APPLICATIONS

This application is based upon and claims the benefit of priority from prior Japanese Patent Application No. 2007-243058, filed Sep. 19, 2007, the entire contents of which are incorporated herein by reference.

### BACKGROUND OF THE INVENTION

1. Field of the Invention

The present invention relates to a resolution-converting apparatus and a resolution-converting method, both designed to convert a high-resolution video content to a low-resolution video content, and relates also to a previewing apparatus, too.

2. Description of the Related Art

The technique of transferring high-resolution, compressed broadcast contents, such as high-definition (HD) contents, at high speed between video servers is progressing. It is therefore desired that a method be provided, which can generate low-resolution preview images from the high-resolution broadcast contents at high speed so that the images of any content transferred may be viewed and confirmed.

In order to convert a high-resolution broadcast content, such as moving-picture experts group (MPEG) content, to a low-resolution video content, the high-resolution broadcast content is usually first decoded and then converted to a low-resolution video content. The time spent in decoding the high-resolution broadcast content is long. The time required for generating preview images is inevitably long. Techniques relevant to the present invention are disclosed in Jpn. Pat. Appln. KOKAI Publications Nos. 2003-78856, 11-73410 and 8-98173.

As mentioned above, the long time is required to decode a high-resolution, compressed video content in order to generate a low-resolution video content for use in previewing images. This hinders an increase in the speed of converting the resolution.

### BRIEF SUMMARY OF THE INVENTION

According to an aspect of this invention, there is provided a resolution-converting apparatus that includes: an input interface configured to input a video content compression-encoded and having first resolution, together with a second resolution which has been designated and which is lower than the first resolution; a parameter calculator configured to calculate value n (natural number) when 1/2ⁿ times the first resolution is higher than the second resolution; a first converter configured to convert the video content of the first resolution in a frequency domain, to a video content having 1/2ⁿ times the first resolution, by using the value n calculated by the parameter calculator; a decoder configured to decode the video content converted by the first converter; and a second converter configured to convert, in a space domain, the resolution of the video content decoded, to a video content of the designated second resolution.

According to another aspect of this invention, there is provided a resolution-converting method that includes: inputting a video content compression-encoded and having first resolution, together with a second resolution which has been designated and which is lower than the first resolution; calculating value n (natural number) when 1/2ⁿ times the first resolution is higher than the second resolution; converting the video content of the first resolution in a frequency domain, to a video content having 1/2ⁿ times the first resolution, by using the value n calculated; decoding the video content converted; and converting, in a space domain, the resolution of the video content decoded, to a video content of the designated second resolution.

According to still another aspect of this invention, there is provided a previewing apparatus that includes: an input interface configured to input a video content compression-encoded and having first resolution, together with a second resolution which has been designated and which is lower than the first resolution; a parameter calculator configured to calculate value n (natural number) when 1/2ⁿ times the first resolution is higher than the second resolution; a first converter configured to convert the video content of the first resolution in a frequency domain, to a video content having 1/2ⁿ times the first resolution, by using the value n calculated by the parameter calculator; a decoder configured to decode the video content converted by the first converter; a second converter configured to convert, in a space domain, the resolution of the video content decoded, to a video content of the designated second resolution; and a display configured to display a video content output from the second converter and having the second resolution.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a resolution-converting apparatus according to an embodiment of the present invention;

FIG. 2 is a diagram outlining the operation of the resolution-converting apparatus shown in FIG. 1; and

FIG. 3 is a flowchart explaining the operation sequence of the resolution-converting apparatus shown in FIG. 1.

### DETAILED DESCRIPTION OF THE INVENTION

An embodiment of this invention will be described in detail, with reference to the accompanying drawings.

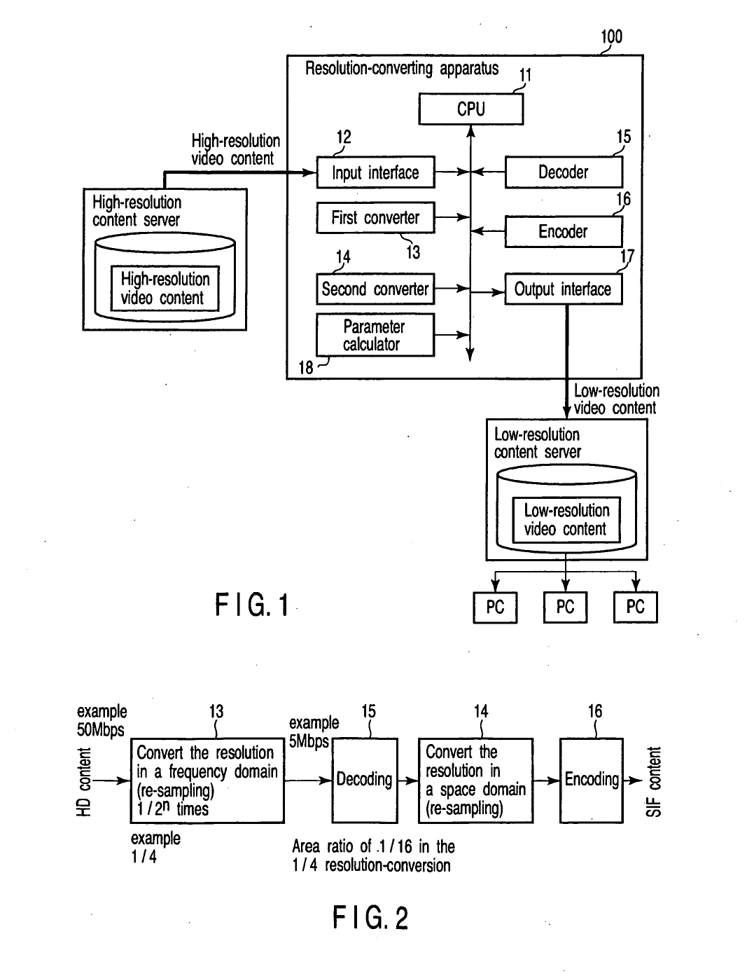

FIG. 1 is a block diagram showing a resolution-converting apparatus according to an embodiment of the invention. FIG. 2 is a diagram that outlines the operation of the resolution-converting apparatus.

The resolution-converting apparatus 100 is configured to receive a compressed, high-resolution video content input from a high-resolution content server, to convert this video content to a low-resolution video content, and to store the low-resolution video content in a low-resolution content server. To the low-resolution content server, a personal computer (PC) is connected by a network such as Local Area Network (LAN). The low-resolution content server transmits the low-resolution video content to the PC in response to a preview request transmitted from the PC. The PC receives the low-resolution video content and displays the image represented by the video content.

In the embodiment, the high-resolution content server stores an HD content of first resolution (1920×1080), which is compression-encoded in the moving-picture experts group (MPEG) scheme. The resolution-converting apparatus 100 converts the HD content to a source-input format (SIF) content of second resolution (352×240). Note that any resolution can be selected for the video content. Further, the scheme of compression-coding the video content is not limited to the MPEG scheme. Any other compression-coding scheme using orthogonal transform, such as discrete cosine transform (DCT).

The resolution-converting apparatus 100 includes a central processing unit (CPU) 11, an input interface 12, a first converter 13, a second converter 14, a decoder 15, an encoder 16, an output interface 17, and a parameter calculator 18.

The input interface 12 acquires the HD content of first resolution, compressed in the MPEG scheme and transmitted at 50 Mbps from the high-resolution content server under the control of the CPU 11. The input interface 12 also accepts the designation of the second resolution (SIF) to which the resolution of the input content should be converted. The first converter 13 has the function of converting the resolution of the input video content in a frequency domain. The MPEG scheme adopts DCT that is one of the orthogonal transforms for converting video data to frequency components. In DCT, a video signal is divided into blocks each consisting of 8 (vertical)×8 (horizontal) pixels, and the blocks are encoded, one by one. The first converter 13 performs resolution conversion in a DCT frequency domain. More precisely, the first converter 13 can convert the resolution to 1/2ⁿ times the first resolution, while maintaining the HD content in compressed state. The parameter calculator 18 calculates a parameter n of such a value that renders 1/2ⁿ times the first resolution (wherein n is a natural number) higher than the second resolution.

The decoder 15 decodes, in a frequency domain, the video content whose resolution has been converted to 1/2ⁿ times the first resolution by the first converter 13. As shown in FIG. 2, the area ratio is 1/16 and the transmission rate is about 5 Mbps if the first converter 13 converts the resolution to a quarter (¼). The decoder 15 can therefore perform decoding at high speed. The second converter 14 has the function of converting the resolution of the input video content in a space domain. The second converter 14 converts the video content decoded by the decoder 15, to the second resolution (SIF). The encoder 16 receives the video content of the second resolution (SIF) from the second converter 14 and performs compression encoding of a prescribed scheme (e.g., MPEG) on this video content. The output interface 17 outputs the compression-encoded content of the second resolution (SIF), thus acquired, to the low-resolution content server.

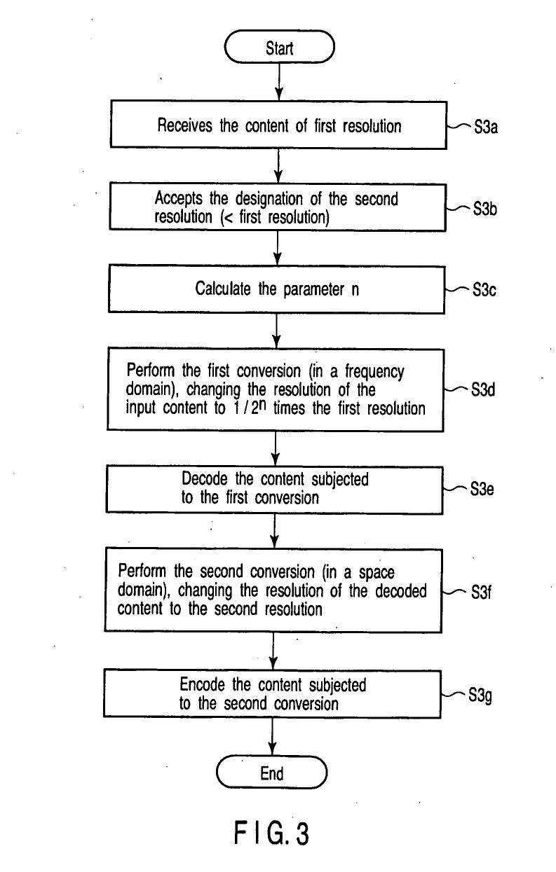

How the resolution-converting apparatus 100 so configured as described above operates will be explained. FIG. 3 is a flowchart explaining the operation sequence of the resolution-converting apparatus 100.

In the resolution-converting apparatus 100, the CPU 11 receives the content of first resolution (HD) from the high-resolution content server via the input interface 12. (Step S3a). Further, the CPU 11 accepts the designation of the second resolution (SIF) to which the resolution of the input content should be converted (Step S3b).

The CPU 11 causes the parameter calculator 18 to calculate the value of n if 1/2ⁿ times the first resolution is higher than the second resolution (Step S3c). In the embodiment, the value of parameter n is either 1 or 2. The greater of these values may be used applied as parameter. This is because, the greater the parameter n, the smaller will be the data that the decoder 15 should decode, and the faster the decoder 15 can decode the data.

The CPU 11 uses the value of n, calculated by the parameter calculator 18, causing the first converter 13 to convert the resolution of the HD content in a frequency domain to 1/2ⁿ time the first resolution (Step S3d). In the technique of compressing data, such as the MPEG scheme that adopts DCT, frequency conversion is performed on each 8×8 pixel block and the block is expressed along with a motion vector. To reduce the resolution to 1/2ⁿ time the first resolution, for example to ½ or ¼, the sampling may be performed at a frequency that corresponds to ½ or ¼ of the motion vector. This can be accomplished by a simple conversion process. The first converter 13 performs this conversion, converting the resolution (1920×1080) of the HD content to a quarter (¼), (i.e., resolution of 480×270).

The CPU 11 causes the decoder 15 to decode the video content whose resolution has been reduced to 1/2ⁿ times the first resolution by the first converter 13 (Step S3e). Then, the CPU 11 performs resolution conversion in a space domain, converting the video content the video content (resolution=480×270) thus decoded to a SIF video content of the second resolution designated (i.e., 352×270) (Step S3f). The CPU 11 then causes the encoder 16 to perform compression encoding of the prescribed scheme on the SIF video content of second resolution (Step S3g). As a result, the SIF video content obtained by converting the HD content is output from the output interface 17 to the low-resolution content server.

As described above, the embodiment performs resolution conversion in a DCT frequency domain, first converting an HD content to a content whose resolution is 1/2ⁿ times the first resolution, e.g., ½ resolution (960×540) or ¼ resolution (480×270), of in order to convert the HD content (1920×1080, e.g., 50 Mbps) to a low-frequency video content. Thus, the high-resolution video content is converted to a low-resolution content that has been compression-encoded, before it is decoded. This can decrease the load on the decoder 15 and shorten the time required for the conversion of resolution.

Hence, the embodiment described above can convert a compressed, high-resolution video content to a low-resolution video content at high speed. Since the resolution is converted at high speed, previewing can be performed to confirm whether the content has been duly transferred, at the same time the high-resolution video content is completely transferred.

The present invention is not limited to the embodiment described above. For example, the second converter 14 need not perform the conversion of resolution if the second resolution designated is 1/2ⁿ times the first resolution. Further, the resolution-converting apparatus 100 may have a display unit. Then, the content of the second resolution, generated by the second converter 14, can be output to the display unit, without being encoded, whereby previewing is accomplished. Still further, various changes and modifications can be made without departing from the scope and spirit of the invention. For example, the resolution-converting apparatus 100 may be changed in configuration, and all function modules may operate as the CPU executes software.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A resolution-converting apparatus comprising:
input interface configured to input a video content compression-encoded and having first resolution, together with a second resolution which has been designated and which is lower than the first resolution;
a parameter calculator configured to calculate value n (natural number) when 1/2ⁿ times the first resolution is higher than the second resolution;
a first converter configured to convert the video content of the first resolution in a frequency domain, to a video content having 1/2ⁿ times the first resolution, by using the value n calculated by the parameter calculator;
a decoder configured to decode the video content converted by the first converter; and
a second converter configured to convert, in a space domain, the resolution of the video content decoded, to a video content of the designated second resolution.

2. The apparatus according to claim 1, wherein the first converter samples the video content of the first resolution at a frequency corresponding to a sampling frequency of the video content having the first resolution or to 1/2ⁿ times a motion vector.

3. A resolution-converting method comprising:
inputting a video content compression-encoded and having first resolution, together with a second resolution which has been designated and which is lower than the first resolution;
calculating value n (natural number) when 1/2ⁿ times the first resolution is higher than the second resolution;
converting the video content of the first resolution in a frequency domain, to a video content having 1/2ⁿ times the first resolution, by using the value n calculated;
decoding the video content converted; and
converting, in a space domain, the resolution of the video content decoded, to a video content of the designated second resolution.

4. The method according to claim 3, wherein the first resolution is converted in a frequency domain, by sampling the video content of the first resolution at a frequency corresponding to a sampling frequency of the video content having the first resolution or to 1/2ⁿ times a motion vector.

5. A previewing apparatus comprising:
an input interface configured to input a video content compression-encoded and having first resolution, together with a second resolution which has been designated and which is lower than the first resolution;
a parameter calculator configured to calculate value n (natural number) when 1/2ⁿ times the first resolution is higher than the second resolution;
a first converter configured to convert the video content of the first resolution in a frequency domain, to a video content having 1/2ⁿ times the first resolution, by using the value n calculated by the parameter calculator;
a decoder configured to decode the video content converted by the first converter;
a second converter configured to convert, in a space domain, the resolution of the video content decoded, to a video content of the designated second resolution; and
a display configured to display a video content output from the second converter and having the second resolution.
